(19) United States
(12) Patent Application Publication
(10) Pub. No.: US 2021/0349379 A1
(43) Pub. Date: Nov. 11, 2021

(54) WAVELENGTH CONVERSION MODULE AND PROJECTOR

(71) Applicant: Coretronic Corporation, Hsin-Chu (TW)

(72) Inventors: Jhih-Hao Chen, Hsin-Chu (TW); Tsung-Ching Lin, Hsin-Chu (TW)

(73) Assignee: Coretronic Corporation, Hsin-Chu (TW)

(21) Appl. No.: 17/213,262

(22) Filed: Mar. 26, 2021

(30) Foreign Application Priority Data
May 6, 2020 (CN) 202020720153.4

(51) Int. Cl. G03B 21/16; G02B 7/00; G03B 21/20

(52) U.S. Cl. CPC G03B 21/16; G03B 21/2066; G03B 21/204; G02B 7/008

(57) ABSTRACT

A wavelength conversion module and a projector including the wavelength conversion module are provided. The wavelength conversion module includes a heat dissipation structure and at least one wavelength conversion layer. The heat dissipation structure has a reflection surface and a heat dissipation surface opposite to each other. The wavelength conversion layer is disposed on the reflection surface and located on a transmission path of an excitation beam. The wavelength conversion layer is configured to convert a wavelength of the excitation beam. The heat dissipation structure is configured to perform heat dissipation on the wavelength conversion layer through the heat dissipation surface. The wavelength conversion module can reduce manufacturing costs, has a good heat dissipation effect, and can reduce the noise of the projector during operation.

### CROSS-REFERENCE TO RELATED APPLICATION

This application claims the priority benefit of China application serial no. 202020720153.4, filed on May 6, 2020. The entirety of the above-mentioned patent application is hereby incorporated by reference herein and made a part of this specification.

### BACKGROUND OF THE INVENTION

### 1. Field of the Invention

The invention relates to an optical module and an optical device, and more particularly, to a wavelength conversion module and a projector.

### 2. Description of Related Art

Recently, projection devices dominated by solid-state light sources such as light-emitting diodes (LEDs) and laser diodes have gradually gained a place in the market. Since the laser diodes have a luminous efficiency higher than about 20% compared with the LEDs, in order to break the light source limitation of the LEDs, a technology of exciting a phosphor by a laser light source to generate a solid color light source required for a projector has been gradually developed. In addition, a laser projection device uses a laser beam provided by a laser diode to excite a phosphor to emit light as a projector illumination source, so as to meet the requirements of a projector with different brightness.

In a current laser projector, a phosphor adhesive layer is generally coated on a highly-reflective metal substrate to form a phosphor wheel, and then a laser beam emitted by a laser light source device excites the phosphor layer of the phosphor wheel on the metal substrate to generate beams of different colors (such as a green light and a yellow light). Moreover, the laser beam (such as a blue light) may directly pass through the phosphor wheel via a hollow slot on the metal substrate or a light-transmitting plate disposed on the metal substrate, thereby generating various color lights. In order to avoid that the phosphor layer at a certain position is continuously irradiated by the laser beam to cause excess temperature, a motor is generally used to drive the phosphor wheel to rotate such that the laser beam is sequentially irradiated to the phosphor layers at different positions with the rotation of the phosphor wheel, and a heat dissipation effect is achieved using an air flow generated during the rotation of the phosphor wheel, or a heat dissipation fan is further used to perform heat dissipation on the phosphor layers. However, this design mode requires a large-area phosphor layer on the metal substrate and the motor, which greatly increases the manufacturing costs, and when rotating, the phosphor wheel will generate noise due to vibration.

The information disclosed in the “BACKGROUND OF THE INVENTION” section is only for enhancement of understanding of the background of the described technology and therefore it may contain information that does not form the prior art that is already known to a person of ordinary skill in the art. Further, the information disclosed in the “BACKGROUND OF THE INVENTION” section does not mean that one or more problems to be resolved by one or more embodiments of the invention was acknowledged by a person of ordinary skill in the art.

### SUMMARY OF THE INVENTION

The invention provides a wavelength conversion module and a projector, which can reduce manufacturing costs, have a good heat dissipation effect, and can reduce the noise of the projector during operation.

Other objectives and advantages of the invention may be further understood from the technical features disclosed in the invention.

In order to achieve one, some, or all of the aforementioned objectives or other objectives, an embodiment of the invention provides a wavelength conversion module, which includes a heat dissipation structure and at least one wavelength conversion layer. The heat dissipation structure has a reflection surface and a heat dissipation surface opposite to each other. The wavelength conversion layer is disposed on the reflection surface and located on a transmission path of an excitation beam. The wavelength conversion layer is configured to convert a wavelength of the excitation beam. The heat dissipation structure is configured to perform heat dissipation on the wavelength conversion layer through the heat dissipation surface.

In order to achieve one, some, or all of the aforementioned objectives or other objectives, an embodiment of the invention provides a projector, which includes a light source, a wavelength conversion module, a light valve, and a projection lens. The light source is configured to provide an excitation beam. The wavelength conversion module includes a heat dissipation structure and at least one wavelength conversion layer. The heat dissipation structure has a reflection surface and a heat dissipation surface opposite to each other. The wavelength conversion layer is disposed on the reflection surface and located on a transmission path of an excitation beam. The wavelength conversion layer is configured to convert a wavelength of the excitation beam to form a converted beam. The heat dissipation structure is configured to perform heat dissipation on the wavelength conversion layer through the heat dissipation surface. The light valve is configured to convert the converted beam into an image beam. The projection lens is configured to project the image beam.

Based on the foregoing, the embodiments of the invention have at least one of the following advantages or effects. In the invention, the wavelength conversion layer is disposed on the reflection surface of the heat dissipation structure, so that the converted beam excited by the wavelength conversion layer being irradiated by an excitation beam is reflected by the reflection surface of the heat dissipation structure and then transmitted to a light valve, and heat generated when the wavelength conversion layer is irradiated by the excitation beam is directly transmitted to the heat dissipation surface of the heat dissipation structure and thus dissipated on the heat dissipation surface. That is, the invention combines the heat dissipation structure and the wavelength conversion layer while meeting the requirements of wavelength conversion and heat dissipation. Therefore, it is not necessary to dispose a large-area phosphor layer on a metal substrate to form a phosphor wheel and use a motor to drive the phosphor wheel to rotate in order to meet the requirements of heat dissipation as in the conventional design mode, so that manufacturing costs can be reduced and the noise of the projector during operation can be reduced.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic view of a projector according to an embodiment of the invention.

FIG. 2 is a schematic side view of a wavelength conversion module in FIG. 1.

FIG. 3A and FIG. 3B are schematic front views of some members of the wavelength conversion module in FIG. 2.

FIG. 4 is a schematic side view of a wavelength conversion module according to another embodiment of the invention.

FIG. 5 is a schematic side view of a wavelength conversion module according to another embodiment of the invention.

FIG. 6 is a schematic side view of a wavelength conversion module according to another embodiment of the invention.

FIG. 7 is a schematic side view of a wavelength conversion module according to another embodiment of the invention.

FIG. 8 is a schematic side view of a wavelength conversion module according to another embodiment of the invention.

FIG. 9 is a schematic side view of a wavelength conversion module according to another embodiment of the invention.

### DESCRIPTION OF THE EMBODIMENTS

In the following detailed description of the preferred embodiments, reference is made to the accompanying drawings which form a part hereof, and in which are shown by way of illustration specific embodiments in which the invention may be practiced. In this regard, directional terminology, such as “top,” “bottom,” “front,” “back,” etc., is used with reference to the orientation of the Figure(s) being described. The components of the present invention can be positioned in a number of different orientations. As such, the directional terminology is used for purposes of illustration and is in no way limiting. On the other hand, the drawings are only schematic and the sizes of components may be exaggerated for clarity. It is to be understood that other embodiments may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted” and variations thereof herein are used broadly and encompass direct and indirect connections, couplings, and mountings. Similarly, the terms “facing,” “faces” and variations thereof herein are used broadly and encompass direct and indirect facing, and “adjacent to” and variations thereof herein are used broadly and encompass directly and indirectly “adjacent to”. Therefore, the description of “A” component facing “B” component herein may contain the situations that “A” component directly faces “B” component or one or more additional components are between “A” component and “B” component. Also, the description of “A” component “adjacent to” “B” component herein may contain the situations that “A” component is directly “adjacent to” “B” component or one or more additional components are between “A” component and “B” component. Accordingly, the drawings and descriptions will be regarded as illustrative in nature and not as restrictive.

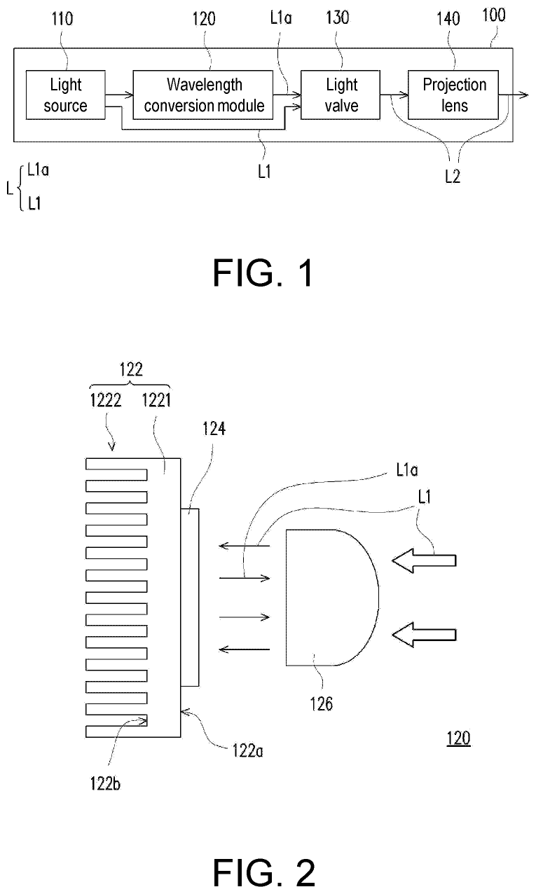

FIG. 1 is a schematic view of a projector according to an embodiment of the invention. FIG. 2 is a schematic side view of a wavelength conversion module in FIG. 1. Referring to FIG. 1, a projector 100 of the embodiment includes a light source 110, a wavelength conversion module 120, a light valve 130, and a projection lens 140. The light source 110 is, for example, a solid-state light source such as an LED or a laser diode. In the embodiment, the light source 110 is configured to provide an excitation beam L1 such as a laser beam, which is, for example, a blue beam. The wavelength conversion module 120 is located on a transmission path of the excitation beam L1 and is configured to convert a wavelength of the excitation beam L1 to generate a converted beam L1a having different wavelengths. In an embodiment, part of the excitation beam L1 emitted by the light source 110 is transmitted via other optical elements (such as a lens or a beam splitter) and does not pass through the wavelength conversion module 120, part of the excitation beam L1 and the converted beam Lla form an illumination beam L, and the illumination beam L may include the excitation beam L1 and the converted beam L1a. In another embodiment, the illumination beam L may be the converted beam Lla.

The light valve 130 is located on a transmission path of the illumination beam L and is configured to convert the illumination beam L into an image beam L2. The projection lens 140 is located on a transmission path of the image beam L2 and is configured to project the image beam L2 out of the projector 100.

Referring to FIG. 2, the wavelength conversion module 120 includes a heat dissipation structure 122 and a wavelength conversion layer 124. The heat dissipation structure 122 has a reflection surface 122a and a heat dissipation surface 122b opposite to each other. The reflection surface 122a has, for example, a reflection coating or the reflection surface 122a is polished, so that the reflection surface 122a is configured to reflect a beam. The wavelength conversion layer 124 is, for example, a phosphor layer, which is disposed on the reflection surface 122a and located on the transmission path of the excitation beam L1. The wavelength conversion layer 124 is configured to convert the wavelength of the excitation beam L1 to convert the excitation beam into the converted beam L1a, and the heat dissipation structure 122 is configured to perform heat dissipation on the wavelength conversion layer 124 through the heat dissipation surface 122b.

Under the above disposing mode, the wavelength conversion layer 124 is irradiated by the excitation beam L1 to excite the converted beam L1a, the converted beam L1a is reflected by the reflection surface 122a of the heat dissipation structure 122 and then transmitted to the light valve 130, and heat generated when the wavelength conversion layer 124 is irradiated by the excitation beam L1 is directly transmitted to the heat dissipation surface 122b of the heat dissipation structure 122 and thus dissipated on the heat dissipation surface 122b. That is, the heat dissipation structure 122 and the wavelength conversion layer 124 are combined while the requirements of wavelength conversion and heat dissipation are met. Therefore, it is not necessary to dispose a large-area phosphor layer on a metal substrate to form a phosphor wheel and use a motor to drive the phosphor wheel to rotate in order to meet the requirements of heat dissipation as in the conventional design mode. In other words, the wavelength conversion module 120 may be a fixed device, that is, the wavelength conversion module 120 may have no additional driving device, so that manufacturing costs can be reduced and the noise of the projector 100 during operation can be reduced.

In the embodiment, the wavelength conversion layer 124 may, for example, convert the excitation beam L1 into a yellow converted beam L1a, and the yellow converted beam L1a may become a red beam and a green beam through a filter element (not shown), and may be transmitted to the light valve 130 together with the blue beam (excitation beam L1) provided by the light source 110. In other embodiments, the wavelength conversion layer 124 may convert the excitation beam L1 into converted beams L1a of other colors, which is not limited in the invention.

As shown in FIG. 2, a material of the heat dissipation structure 122 of the embodiment may be metal, ceramics, high heat conduction plastics, and other high heat conduction materials. The heat dissipation structure 122 includes a heat conduction base 1221 and a heat dissipation fin group 1222. The reflection surface 122a is formed on one side of the heat conduction base 1221. The heat dissipation surface 122b is formed on the other side of the heat conduction base 1221. The heat dissipation fin group 1222 is connected to or formed on the heat dissipation surface 122b of the heat conduction base 1221, thereby increasing a heat dissipation area of the heat conduction base 1221 on the heat dissipation surface 122b. In an embodiment, the heat dissipation structure 122 may be a homogeneous heat sink, and has a coefficient of heat conduction greater than or equal to 5 watts per meter-Kelvin (W/mK).

The wavelength conversion module 120 of the embodiment may further include a lens 126. The lens 126 is located on the transmission path of the excitation beam L1. The excitation beam L1 is configured to reach the wavelength conversion layer 124 after passing through the lens 126 and be converted into the converted beam L1a, is reflected by the reflection surface 122a, and is configured to be transmitted to the light valve 130 through the lens 126 after being reflected by the reflection surface 122a.

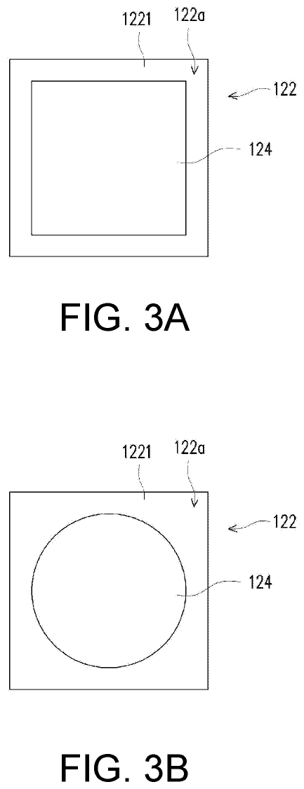

FIG. 3A and FIG. 3B are schematic front views of some members of the wavelength conversion module in FIG. 2. A distribution region of the wavelength conversion layer 124 on the reflection surface 122a of the heat dissipation structure 122 may be rectangular as shown in FIG. 3A and circular as shown in FIG. 3B, which is not limited in the invention. The wavelength conversion layer 124 may be in other suitable shapes on the reflection surface 122a of the heat dissipation structure 122. In addition, an area of the reflection surface 122a of the heat dissipation structure 122 is, for example, at least 1.33 times that of the distribution region of the wavelength conversion layer 124, and energy of the excitation beam L1 irradiated to the wavelength conversion layer 124 is, for example, less than or equal to 100 watts. The defined energy refers to a radiant flux irradiated on the wavelength conversion layer 124 per unit time, but the invention is not limited thereto.

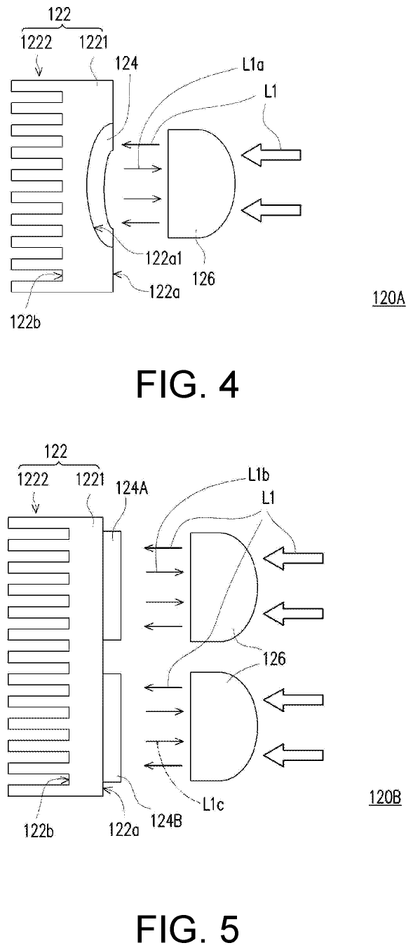

FIG. 4 is a schematic side view of a wavelength conversion module according to another embodiment of the invention. A wavelength conversion module 120A shown in FIG. 4 is different from the wavelength conversion module 120 shown in FIG. 2 in that: the reflection surface 122a of the heat dissipation structure 122 of the wavelength conversion module 120A has a groove 122a1, the groove 122a1 is, for example, composed of a concave arc surface, and the wavelength conversion layer 124 is disposed in the groove 122a1 and located on the concave arc surface. Therefore, a contact area between the wavelength conversion layer 124 and the heat dissipation structure 122 can be increased to improve the heat dissipation efficiency.

FIG. 5 is a schematic side view of a wavelength conversion module according to another embodiment of the invention. A wavelength conversion module 120B shown in FIG. 5 is different from the wavelength conversion module 120 shown in FIG. 2 in that: the wavelength conversion module 120B in FIG. 5 includes a first wavelength conversion layer 124A and a second wavelength conversion layer 124B. The first wavelength conversion layer 124A and the second wavelength conversion layer 124B are disposed in different regions on the reflection surface 122a respectively. There are two lenses 126 correspondingly. The two lenses 126 correspond to the first wavelength conversion layer 124A and the second wavelength conversion layer 124B respectively. The first wavelength conversion layer 124A and the second wavelength conversion layer 124B convert the excitation beam L1 into a first converted beam L1b and a second converted beam L1c respectively. The first converted beam L1b and the second converted beam L1c are different in wavelength. In the embodiment, the first converted beam L1b is, for example, a red beam, and the second converted beam L1c is, for example, a green beam, which are transmitted to the light valve 130 together with the blue excitation beam provided by the light source 110.

In detail, a main wavelength of the first converted beam L1b is different from that of the second converted beam L1c, a wavelength range of the first converted beam L1b is a wavelength range of a red light, and a wavelength range of the second converted beam L1c is a wavelength range of a green light. In an embodiment, the wavelength range of the first converted beam L1b and the wavelength range of the second converted beam L1c may be partially overlapped.

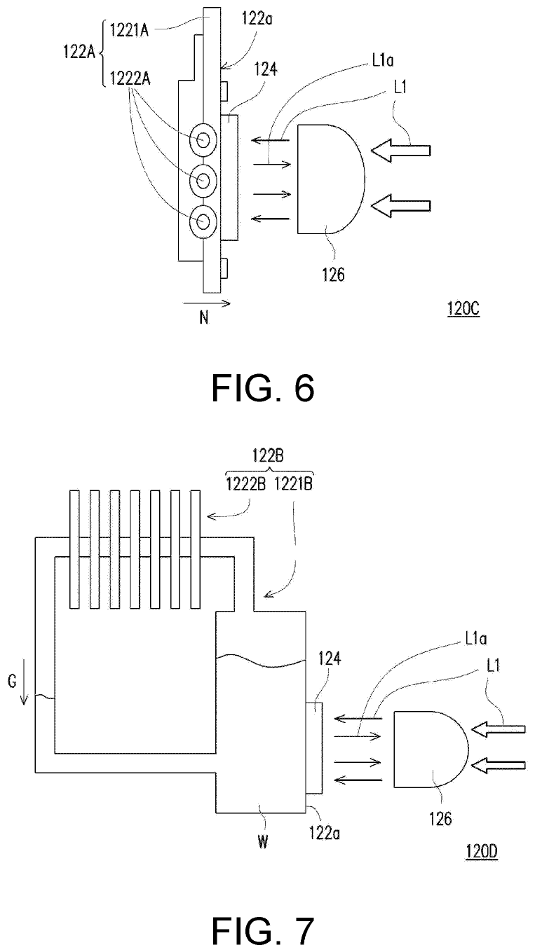

FIG. 6 is a schematic side view of a wavelength conversion module according to another embodiment of the invention. A wavelength conversion module 120C shown in FIG. 6 is different from the wavelength conversion module 120 shown in FIG. 2 in that: a heat dissipation structure 122A includes a base 1221A and a plurality of heat pipes 1222A. The reflection surface 122a is formed on a side of the base 1221A away from the plurality of heat pipes 1222A. The heat pipes 1222A are connected to or formed on the base 1221A, and at least part of the heat pipes 1222A overlap the wavelength conversion layer 124 in a normal direction N in a projection region of the reflection surface 122a, so as to effectively perform heat dissipation on the wavelength conversion layer 124.

FIG. 7 is a schematic side view of a wavelength conversion module according to another embodiment of the invention. A wavelength conversion module 120D shown in FIG. 7 is different from the wavelength conversion module 120 shown in FIG. 2 in that: a heat dissipation structure 122B includes a thermosiphon device 1221B and a heat dissipation fin group 1222B, the reflection surface 122a is formed on one side of the thermosiphon device 1221B, and the heat dissipation fin group 1222B is connected to the thermosiphon device 1221B. The thermosiphon device 1221B is configured to contain a working liquid W. A liquid level of the working liquid W (while the working liquid W is in a static state) is located above the wavelength conversion layer 124 in a direction of gravity G, and the heat dissipation fin group 1222B is arranged above the wavelength conversion layer 124 in the direction of gravity G. The above arrangement relationship may effectively utilize a thermosiphon principle to perform heat dissipation on the wavelength conversion layer 124. That is, the working liquid W receives the heat of the wavelength conversion layer 124 and vaporizes, and moves upward to the heat dissipation fin group 1222B for heat exchange. After heat exchange at the heat dissipation fin group 1222B, the vaporized working liquid condenses into a liquid and flows back. In other words, the heat dissipation structure 122B may be a heterogeneous two-phase flow heat sink. The invention is not limited thereto.

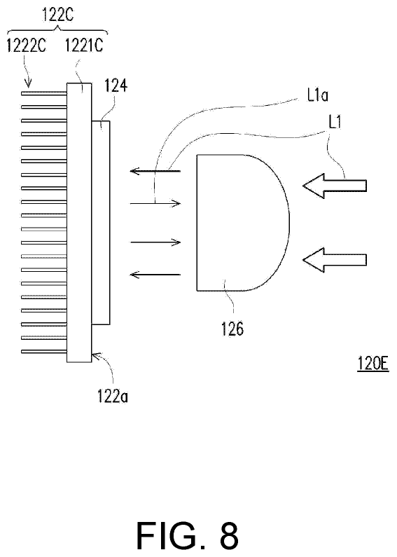

FIG. 8 is a schematic side view of a wavelength conversion module according to another embodiment of the invention. A wavelength conversion module 120E shown in FIG. 8 is different from the wavelength conversion module 120 shown in FIG. 2 in that: the wavelength conversion module 120E replaces the heat dissipation base 1221 in FIG. 2 with a vapor chamber 1221C. A heat dissipation structure 122C includes the vapor chamber 1221C and a heat dissipation fin group 1222C. The reflection surface 122a is formed on one side of the vapor chamber 1221C. The heat dissipation fin group 1222C is connected to the other side of the vapor chamber 1221.

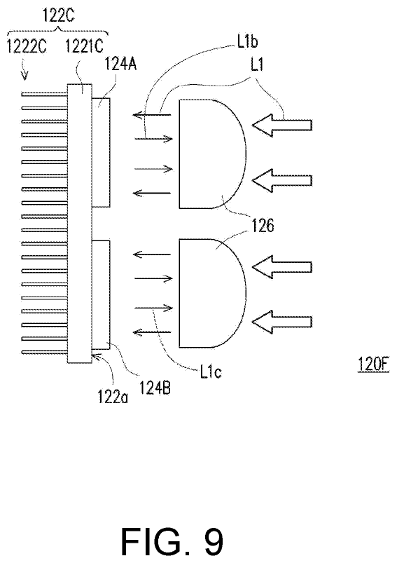

FIG. 9 is a schematic side view of a wavelength conversion module according to another embodiment of the invention. A wavelength conversion module 120F shown in FIG. 9 is different from the wavelength conversion module 120B shown in FIG. 5 in that: the wavelength conversion module 120F replaces the heat dissipation base 1221 in FIG. 5 with a vapor chamber 1221C. A heat dissipation structure 122C includes the vapor chamber 1221C and a heat dissipation fin group 1222C. The reflection surface 122a is formed on one side of the vapor chamber 1221C. The heat dissipation fin group 1222C is connected to the other side of the vapor chamber 1221.

It is to be particularly noted that the wavelength conversion module 120B shown in FIG. 5 and the wavelength conversion module 120F shown in FIG. 9 may have a groove (not shown) in other embodiments to dispose the first wavelength conversion layer 124A and the second wavelength conversion layer 124B in the groove. In an embodiment, the wavelength conversion module 120B shown in FIG. 5 and the wavelength conversion module 120F shown in FIG. 9 may have a plurality of grooves (not shown) to dispose the first wavelength conversion layer 124A and the second wavelength conversion layer 124B in different grooves respectively. A concave arc surface in the groove may increase a contact area between the wavelength conversion layer 124 and the heat dissipation structure 122 to improve the heat dissipation efficiency. On the other hand, the concave arc surface in the groove may provide an effect of converging the converted beam L1a.

Based on the foregoing, the embodiments of the invention have at least one of the following advantages or effects. In the invention, the wavelength conversion layer is disposed on the reflection surface of the heat dissipation structure, so that the converted beam excited by the wavelength conversion layer being irradiated by the excitation beam is reflected by the reflection surface of the heat dissipation structure and then transmitted to a light valve, and heat generated when the wavelength conversion layer is irradiated by the excitation beam is directly transmitted to the heat dissipation surface of the heat dissipation structure and thus dissipated on the heat dissipation surface. That is, the invention combines the heat dissipation structure and the wavelength conversion layer while meeting the requirements of wavelength conversion and heat dissipation. Therefore, it is not necessary to dispose a large-area phosphor layer on a metal substrate to form a phosphor wheel and use a motor to drive the phosphor wheel to rotate in order to meet the requirements of heat dissipation as in the conventional design mode, so that manufacturing costs can be reduced and the noise of the projector during operation can be reduced.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable a person skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. Moreover, these claims may refer to use “first”, “second”, etc. following with noun or element. Such terms should be understood as a nomenclature and should not be construed as giving the limitation on the number of the elements modified by such nomenclature unless specific number has been given. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by a person skilled in the art without departing from the scope of the present invention as defined by the following claims. Moreover, no element and component in the present disclosure is intended to be dedicated to the public regardless of whether the element or component is explicitly recited in the following claims.

What is claimed is:

1. A wavelength conversion module, comprising a heat dissipation structure and at least one wavelength conversion layer, wherein
the heat dissipation structure has a reflection surface and a heat dissipation surface opposite to each other; and
the at least one wavelength conversion layer is disposed on the reflection surface and located on a transmission path of an excitation beam, wherein the at least one wavelength conversion layer is configured to convert a wavelength of the excitation beam, and the heat dissipation structure is configured to perform heat dissipation on the at least one wavelength conversion layer through the heat dissipation surface.

2. The wavelength conversion module according to claim 1, wherein the at least one wavelength conversion layer comprises a first wavelength conversion layer and a second wavelength conversion layer, and the first wavelength conversion layer and the second wavelength conversion layer are respectively disposed in different regions on the reflection surface, and respectively convert the excitation beam into a first converted beam and a second converted beam, wherein a wavelength of the first converted beam is different from a wavelength of the second converted beam.

3. The wavelength conversion module according to claim 1, wherein the heat dissipation structure has a groove on the reflection surface, and the at least one wavelength conversion layer is disposed in the groove.

4. The wavelength conversion module according to claim 3, wherein the groove comprises a concave arc surface, and the at least one wavelength conversion layer is disposed on the concave arc surface.

5. The wavelength conversion module according to claim 1, comprising at least one lens, wherein the at least one lens is located on the transmission path of the excitation beam, the excitation beam is configured to reach the at least one wavelength conversion layer after passing through the at least one lens, and the excitation beam is converted into a converted beam and reflected by the reflection surface, and then passes through the at least one lens.

6. The wavelength conversion module according to claim 1, wherein an area of the reflection surface is 1.33 times an area of the at least one wavelength conversion layer.

7. The wavelength conversion module according to claim 1, wherein the heat dissipation structure comprises a heat conduction base and a heat dissipation fin group, the reflection surface is formed on one side of the heat conduction base, and the heat dissipation fin group is connected to another side of the heat conduction base.

8. The wavelength conversion module according to claim 1, wherein the heat dissipation structure comprises a base and at least one heat pipe, the reflection surface is formed on one side of the base, and the at least one heat pipe is connected to the base and overlaps the at least one wavelength conversion layer in a normal direction of the reflection surface.

9. The wavelength conversion module according to claim 1, wherein the heat dissipation structure comprises a thermosiphon device and a heat dissipation fin group, the reflection surface is formed on one side of the thermosiphon device, the heat dissipation fin group is connected to the thermosiphon device, the thermosiphon device is configured to contain a working liquid, and a liquid level of the working liquid and the heat dissipation fin group are located above the at least one wavelength conversion layer in a direction of gravity.

10. The wavelength conversion module according to claim 1, wherein the heat dissipation structure comprises a vapor chamber and a heat dissipation fin group, the reflection surface is formed on one side of the vapor chamber, and the heat dissipation fin group is connected to another side of the vapor chamber.

11. A projector, comprising a light source, a wavelength conversion module, a light valve, and a projection lens, wherein
the light source is configured to provide an excitation beam;
the wavelength conversion module comprises a heat dissipation structure and at least one wavelength conversion layer, wherein the heat dissipation structure has a reflection surface and a heat dissipation surface opposite to each other, the at least one wavelength conversion layer is disposed on the reflection surface and located on a transmission path of the excitation beam, the at least one wavelength conversion layer is configured to convert a wavelength of the excitation beam to form a converted beam, and the heat dissipation structure is configured to perform heat dissipation on the at least one wavelength conversion layer through the heat dissipation surface;
the light valve is configured to convert the converted beam into an image beam; and
the projection lens is configured to project the image beam.

12. The projector according to claim 11, wherein the at least one wavelength conversion layer comprises a first wavelength conversion layer and a second wavelength conversion layer, and the first wavelength conversion layer and the second wavelength conversion layer are respectively disposed in different regions on the reflection surface, and respectively convert the excitation beam into a first converted beam and a second converted beam, wherein a wavelength of the first converted beam is different from a wavelength of the second converted beam.

13. The projector according to claim 11, wherein the heat dissipation structure has a groove on the reflection surface, and the at least one wavelength conversion layer is disposed in the groove.

14. The projector according to claim 13, wherein the groove comprises a concave arc surface, and the at least one wavelength conversion layer is disposed on the concave arc surface.

15. The projector according to claim 11, wherein the wavelength conversion module comprises at least one lens, wherein the at least one lens is located on the transmission path of the excitation beam, the excitation beam is configured to reach the at least one wavelength conversion layer after passing through the at least one lens, and the excitation beam is converted into the converted beam and reflected by the reflection surface, and then passes through the at least one lens.

16. The projector according to claim 11, wherein an area of the reflection surface is 1.33 times an area of the at least one wavelength conversion layer.

17. The projector according to claim 11, wherein the heat dissipation structure comprises a heat conduction base and a heat dissipation fin group, the reflection surface is formed on one side of the heat conduction base, and the heat dissipation fin group is connected to another side of the heat conduction base.

18. The projector according to claim 11, wherein the heat dissipation structure comprises a base and at least one heat pipe, the reflection surface is formed on one side of the base, and the heat pipe is connected to the base and overlaps the at least one wavelength conversion layer in a normal direction of the reflection surface.

19. The projector according to claim 11, wherein the heat dissipation structure comprises a thermosiphon device and a heat dissipation fin group, the reflection surface is formed on one side of the thermosiphon device, the heat dissipation fin group is connected to the thermosiphon device, the thermosiphon device is configured to contain a working liquid, and a liquid level of the working liquid and the heat dissipation fin group are located above the at least one wavelength conversion layer in a direction of gravity.

20. The projector according to claim 11, wherein the heat dissipation structure comprises a vapor chamber and a heat dissipation fin group, the reflection surface is formed on one side of the vapor chamber, and the heat dissipation fin group is connected to another side of the vapor chamber.
